(19) United States
(12) Patent Application Publication
(10) Pub. No.: US 2017/0167486 A1
(43) Pub. Date: Jun. 15, 2017

(54) SCROLL TYPE FLUID MACHINE, METHOD AND DEVICE FOR FORMING ELASTIC COATING THEREON

(71) Applicant: ANEST IWATA CORPORATION, Yokohama-shi (JP)

(72) Inventors: Junichi ASAMI, Yokohama-shi (JP); Toru SATO, Yokohama-shi (JP)

(21) Appl. No.: 15/388,964

(22) Filed: Dec. 22, 2016

Related U.S. Application Data
(62) Division of application No. 13/940,660, filed on Jul. 12, 2013, now abandoned.
Application No. 13/940,660 is a continuation of application No. PCT/JP2011/077753, filed on Dec. 1, 2011.

(30) Foreign Application Priority Data
Jan. 14, 2011 (JP) 2011-006386

(51) Int. Cl. F04C 18/02; B05B 12/02; B05B 13/02; F01C 1/02

(52) U.S. Cl. CPC F04C 18/0269; F01C 1/0269; B05B 12/02; B05B 13/0228; F04C 2230/91; F04C 2240/20; F05C 2251/02; F05C 2251/14

(57) ABSTRACT

A coating solution that contains 10 to 20% by weight of epoxy resin serving as a thermosetting resin, 20 to 30% by weight of MoS₂, and 5 to 10% by weight of graphite, with a remainder thereof constituted by an organic solvent, is sprayed onto a wrap portion side face of an orbiting scroll from a spray nozzle. While spraying the coating solution, the orbiting scroll is rotated on a rotating table and the spray nozzle is moved along a rectilinear movement path toward a radial direction outer side of the orbiting scroll while maintaining an attitude thereof from the start of the spraying process. After applying the coating solution, the coating solution is dried by baking, whereupon a break-in operation is performed. As a result, an elastic coating is formed at a coating thickness that enables elastic deformation in accordance with a clearance between the wrap portion side faces.

### RELATED APPLICATIONS

The present application is a division of U.S. patent application Ser. No. 13/940,660 filed on Jul. 12, 2013, which is a continuation of International Application No. PCT/JP2011/077753, filed Dec. 1, 2011, and claims priority from Japanese Application No. 2011-006386, filed Jan. 14, 2011. The above listed applications are hereby incorporated by reference in their entirety.

### TECHNICAL FIELD

The present invention relates to a scroll type fluid machine, and a method and a device for forming an elastic coating thereon, with which an elastic coating can be formed on a side face of a spiral wrap forming the scroll type fluid machine while preventing seizure, galling, wear, and contact damage on the wrap portion side face.

### BACKGROUND ART

A scroll type fluid machine is used as a scroll type compressor, a scroll type vacuum pump, a scroll type expander, a scroll type air blower, and the like. A scroll type fluid machine is constituted by a fixed scroll and an orbiting scroll having spiral wrap portions that stand upright on end plates thereof, and a driving mechanism that causes the orbiting scroll to orbit without rotating. A plurality of enclosed spaces surrounded by the end plates and the wrap portions of the fixed scroll and the orbiting scroll are formed, and a processing subject gas is introduced into the enclosed spaces and subjected to processing such as compression, expansion, or decompression.

To secure a compression performance, an expansion performance, or the like in a scroll type fluid machine, the enclosed spaces formed by the fixed scroll and the orbiting scroll must be sealed tightly in order to compress or decompress the gas suctioned therein. Meanwhile, to suppress seizure, galling, wear, contact damage, and the like between the wrap portions of the fixed scroll and the orbiting scroll, a minute gap of a size at the micron scale must be formed between the wrap portions of the fixed scroll and the orbiting scroll. In consideration of these points, a high degree of processing precision is required to form the fixed scroll and the orbiting scroll.

However, the fixed scroll and the orbiting scroll are constantly heated or cooled by the gas that is compressed or decompressed in the enclosed spaces, and therefore undergo constant thermal deformation. Moreover, a pressure and a temperature of the gas are different in a central region and an outside region of the scrolls, and therefore thermal strain occurs due to a resulting temperature difference. Scrolls in which thermal strain has occurred are shown in FIG. 3 of Patent Document 2, to be described below.

FIG. 3 of Patent Document 2 is shown in FIG. 7. In FIG. 7, a fixed scroll 100 is constituted by an end plate 102 and a wrap portion 104, while an orbiting scroll 110 is constituted by an end plate 112 and a wrap portion 114. In a scroll type compressor, a temperature and a pressure are low in an outer peripheral portion and increase steadily toward a central portion. Therefore, stress acts on the wrap portion 114 of the orbiting scroll 110 from the central portion toward the outer peripheral portion, causing the wrap portion 114 to deform in the manner of an opening petal. This tendency is also observed in the fixed scroll 100, albeit to a lesser degree. As a result, gaps 120a and 120b between the wrap portions 104, 114 and the end plates 102, 112 increase from the central portion toward the outer peripheral portion.

However, managing a scroll type compressor to ensure that both the enclosed spaces are tightly sealed and the minute gap is secured between the wrap portions is not easy. One method of securing the minute gap between the wrap portions is to apply a coating to a side face or an end face of the wrap. An optimum gap is formed between the wrap portions by interposing a coating film having a lubricating property and a wear-resistant property between the wrap portions, providing the coating film with an impact absorbing function, and scraping away surplus of the coating film during an operation.

Patent Document 1 discloses a configuration in which an elastic coating layer constituted by an elastic material such as rubber or a synthetic resin material is formed on at least one wrap side face of a scroll, and a lubricating coating layer constituted by a self-lubricating material such as a resin material containing molybdenum disulfide (MoS₂), a fluorine-based resin material, or a carbon-based resin material is formed on the elastic coating layer.

Patent Document 2 relates to a scroll type pump, and discloses a configuration and a method for applying a surface coating formed from a coolant-resistant resin containing MoS₂ particles to a wrap portion and an end plate of a scroll. In the coating method, the scroll type pump is assembled and operated after applying the surface coating but before the surface coating hardens, whereby surplus surface coating is discharged to the exterior of the scroll such that the surface coating obtains an appropriate coating thickness.

Patent Document 3 discloses a configuration for forming a lubricating coating layer constituted by a similar self-lubricating material to that of Patent Document 1 on a side face of a wrap portion of a scroll. Patent Document 3 also discloses a method of determining a coating thickness of the lubricating coating layer from a measurement value of a radial clearance formed between side faces of respective wrap portions of a fixed scroll and an orbiting scroll.

Patent Document 4 discloses a scroll compressor in which cast iron having high tensile strength is used as a scroll base material and an impact caused by contact between wrap portions is mitigated by covering the scroll base material with a resin having greater elasticity than the metal of the scroll base material.

Patent Document 1: Japanese Patent Application Publication No. H11-280669

Patent Document 2: Japanese Patent Application Publication No. 2003-35284

Patent Document 3: Japanese Patent Application Publication No. 2009-57897

Patent Document 4: Japanese Patent Application Publication No. 2007-245234

### DISCLOSURE OF THE INVENTION

As described above, a technique of forming a coating layer possessing elasticity or a lubricating property on a side face of a wrap portion of a scroll to ensure that an enclosed space formed between a fixed scroll and an orbiting scroll is sealed tightly and eliminates seizure, galling wear, contact damage, and the like between the wrap portions is well known. A clearance between the wrap side faces is an extremely small gap at the micron scale, and therefore a coating thickness of the costing layer must also be controlled precisely at the micron scale. However, Patent Documents 1 to 4 do not disclose a method of precisely controlling the coating thickness of the coating layer.

In the coating method disclosed in Patent Document 2, the coating is handled in an unhardened state, making it difficult to obtain a precise coating thickness. Further, in Patent Document 3, the coating thickness of the coating layer is determined on the basis of the measurement value of the clearance between the wrap side faces, but the clearance between the wrap side faces takes different values in a center and on an outer side of the wrap portion, and also differs due to thermal deformation of the wrap portion. The clearance between the wrap side faces must therefore be measured in each region, and an optimum coating thickness is not always obtained during an operation.

Moreover, it is not easy to apply the coating layer at an even coating thickness in a lengthwise direction of the wrap side face, and yet none of Patent Documents 1 to 4 discloses a method of making this possible.

In consideration of these problems in the related art, a first object of the present invention is to enable formation of a coating layer with which a tightly sealed enclosed space is formed between a fixed scroll and an orbiting scroll without the need for precise control of a coating thickness and seizure, galling, wear, contact damage, and the like do not occur between wrap side faces. A second object of the present invention is to realize a coating formation device with which an even and highly precise coating thickness can be obtained easily over an entire lengthwise direction of a wrap portion.

To achieve these objects, in a scroll type fluid machine according to the present invention, in which an elastic coating is formed on a side face of a spiral wrap portion, the elastic coating is obtained by dispersing a powdered solid lubricant in a synthetic resin that possesses elasticity and is more flexible than a scroll base material constituting the wrap portion, and is formed at a coating thickness that enables elastic deformation relative to an opposing wrap portion side face of another scroll during an operation while ensuring that a clearance is not generated between the wrap portion side faces.

In this description, the “coating thickness that enables elastic deformation” is a coating thickness at which the elastic coating can adhere tightly to the wrap portion side face in a state of constant elastic deformation during an operation of the scroll type fluid machine without undergoing plastic deformation and without creating a clearance between the wrap portion side faces during the operation. When the coating thickness exceeds the coating thickness that enables elastic deformation, plastic deformation occurs, creating a clearance between the opposing wrap portion side faces, and as a result, an enclosed space cannot be formed. Alternatively, the elastic coating may be damaged by plastic deformation such that the wrap portion side faces contact each other directly, and as a result, the wrap portions may be damaged.

The elastic coating according to the present invention is obtained by dispersing the powdered solid lubricant in the synthetic resin that possesses elasticity and is more flexible than the scroll base material constituting the wrap portion, and therefore favorable lubricating and sliding properties can be obtained in relation to opposing wraps of a fixed scroll and an orbiting scroll. As a result, seizure, galling, wear, contact damage, and the like between opposing wrap portion side faces can be suppressed.

Further, the elastic coating according to the present invention is formed at the coating thickness that enables elastic deformation relative to the opposing wrap portion side face of the other scroll during an operation while ensuring that a clearance is not generated between the wrap portion side faces. Hence, the elastic coating remains tightly adhered to the wrap portion side face at all times, and therefore favorable adhesiveness is realized in relation to the wrap portion side face. As a result, the enclosed space formed between the fixed scroll and the orbiting scroll can be sealed more tightly.

In the scroll type fluid machine according to the present invention, the elastic coating is preferably formed by applying a coating solution obtained by dissolving constituent components of the elastic coating in a solvent, to the wrap portion side face at a coating thickness that exceeds the coating thickness enabling elastic deformation during an operation, drying the coating solution, and then finishing the coating solution to the coating thickness enabling elastic deformation by performing a break-in operation. Hence, in the application process, the coating solution is applied at a coating thickness that exceeds the coating thickness enabling elastic deformation, whereupon the coating solution is then finished to the coating thickness enabling elastic deformation by performing a break-in operation to scrape away or wear down a surplus part. In so doing, fine adjustment of the coating thickness of the coating solution is not required during the application process, and therefore an application operation is easy. Note that spray coating, electrostatic coating, and the like may be used as a method of applying the coating solution.

In the scroll type fluid machine according to the present invention, the elastic coating is preferably formed by applying a coating solution containing 10 to 20% by weight of a synthetic resin having epoxy resin as a main component and 25 to 40% by weight of a powdered solid lubricant having MoS₂ as a main component, with a remainder thereof constituted by the solvent, to the wrap portion side face, and then hardening the coating solution by baking. Epoxy resin is much more flexible than the metal base material constituting the scroll, and also possesses elasticity. Moreover, epoxy resin is a thermosetting resin, and is therefore hardened by baking following application. Fluorine resin is not adhesive and peels away easily following an impact. Greater adhesive strength relative to the wrap portion side face can therefore be obtained with epoxy resin than with fluorine resin. Note that polytetrafluoroethylene (PTFE) or the like may be added to the epoxy resin.

Further, by dispersing the powdered solid lubricant having MoS₂ as the main component in the epoxy resin, the lubricating and sliding properties relative to the opposing wrap portion side face of the other scroll can be improved. In particular, the MoS₂ shifts within the coating upon reception of an impact, thereby absorbing and mitigating the impact. As a result, seizure, galling, wear, contact damage, and the like on the wrap portion side face can be suppressed. The epoxy resin is highly elastic, and therefore enhances the lubricating and sliding effects of the solid lubricant. Note that graphite or the like may be added in addition to the MoS₂.

In the elastic coating formed from the coating solution having the components and composition described above, the coating thickness of the elastic coating following a break-in operation is preferably between 30 and 80 μm. When the coating thickness of the elastic coating is smaller than 30 μm, direct contact occurs between the wrap portion side faces, causing the wrap portions to be damaged. When the coating thickness of the elastic coating is equal to or greater than 30 μm, on the other hand, contact between the wrap portion side faces can be prevented reliably, and as a result, damage to the wrap portions can be prevented.

Further, in the elastic coating formed from the coating solution having the components and composition described above, 80 μm is a maximum coating thickness that can be achieved in a single application, and therefore, when the coating thickness reaches or exceeds 80 μm, variation therein starts to occur. Further, when the coating thickness reaches or exceeds 90 μm, the elastic coating begins to peel away. Hence, by keeping the coating thickness of the elastic coating at or below 80 μm, the adhesive strength can be improved while preventing peeling.

The scroll type fluid machine according to the present invention can be applied equally effectively when a processing subject gas is air and lubricating oil is not used. The elastic coating according to the present invention has MoS₂, which is self-lubricating, as a main component, and therefore the lubricating and sliding properties can be secured sufficiently between the opposing wrap portion side faces even in a scroll type fluid machine to which no lubricating oil is supplied.

A method for forming the above elastic coating according to the present invention includes: a preliminary step of fixing a scroll constituted by a spiral wrap portion and an end plate to a rotating table and rotating the scroll about a spiral center of the wrap portion; a coating solution spraying step of moving a spray nozzle in a radial direction of the scroll while spraying a coating solution obtained by dissolving constituent components of the elastic coating in a solvent, onto the rotating scroll toward a side face of the wrap portion using the spray nozzle; and a coating thickness adjusting step of keeping a coating thickness of the coating solution constant by adjusting a rotation speed of the scroll in accordance with a radial direction movement of the spray nozzle.

In the method according to the present invention, the coating solution is sprayed toward the wrap portion side face from the spray nozzle while rotating the scroll on the rotating table. By adjusting the rotation speed of the scroll and a radial direction movement speed of the spray nozzle relative to the scroll in this condition, the coating can be formed at an even coating thickness. As a result, an even coating can be formed on the wrap portion side face easily.

In the method according to the present invention, a movement speed of the spray nozzle is preferably kept constant, and the rotation speed of the scroll is preferably adjusted in accordance with the movement speed. In this case, the movement speed of the spray nozzle can be kept constant, thereby eliminating the need to adjust the movement speed of the spray nozzle. Hence, only the rotation speed of the scroll need to be controlled during an operation, and therefore control can be performed easily. Accordingly, a control device can be simplified.

Note that when the rotation speed of the scroll remains constant, a peripheral speed of the scroll is greater in an outside region than in a central region. Hence, when the spray nozzle is moved in the radial direction of the scroll at a constant rotation speed, the coating thickness on the side face in the central region is greater than the coating thickness on the side face in the outside region. The rotation speed of the scroll must therefore be varied in accordance with the radial direction coating region of the scroll.

In a specific example of the method according to the present invention, the spray nozzle is preferably moved in an outside direction from the spiral center of the wrap, and the rotation speed of the scroll is preferably reduced gradually in accordance with a movement speed of the spray nozzle. In so doing, the coating thickness of the coating can be made even in the central region and the outside region of the scroll.

In another specific example of the method according to the present invention, the spray nozzle is preferably moved from an outer diameter side toward a center of the scroll, and the rotation speed of the scroll is preferably increased gradually in accordance with a movement speed of the spray nozzle. Likewise, in so doing, the coating thickness of the coating solution can be made even in the central region and the outside region of the scroll.

Further, in the method according to the present invention, in addition to the respective operations described above, the spray nozzle can be moved rectilinearly without varying an attitude thereof. In so doing, an operation of the spray nozzle can be controlled easily, and therefore a so-called uniaxial system can be used as a driving system for the spray nozzle. As a result, a driving device and a control device for the spray nozzle can be simplified.

Furthermore, a device for forming an elastic coating on a scroll type fluid machine according to the present invention, which can be used directly to implement the method according to the present invention described above, includes: a rotation device that includes a rotating table on which a scroll constituted by a wrap portion and an end plate is placed fixedly and a driving device for driving the rotating table, and that rotates the scroll placed fixedly on the rotating table about a spiral center of the wrap portion; a coating solution spraying device having a spray nozzle for spraying a coating solution obtained by dissolving constituent components of the elastic coating in a solvent, onto the rotating scroll toward a side face of the wrap portion, and a driving device for moving the spray nozzle in a radial direction of the scroll; and a controller that keeps a coating thickness of the coating solution constant by controlling a rotation speed of the rotating table and a movement speed of the spray nozzle.

In the elastic coating formation device according to the present invention, the coating solution is sprayed toward the wrap portion side face from the spray nozzle while rotating the scroll on the rotating table. By having the controller adjust the rotation speed of the scroll and the radial direction movement speed of the spray nozzle relative to the scroll in this condition, the elastic coating can be formed at an even coating thickness. As a result, an even coating can be formed on the wrap portion side face with a simple configuration.

In the elastic coating formation device according to the present invention, the coating solution spraying device preferably includes a uniaxial system driving device that moves the spray nozzle along a rectilinear path without varying an attitude of the spray nozzle. Thus, the operation of the spray nozzle can be controlled easily, and therefore a so-called uniaxial system can be used as the driving system for the spray nozzle. As a result, the driving device and the control device for the spray nozzle can be simplified.

In the elastic coating formation device according to the present invention, the spray nozzle preferably includes a slit-shaped discharge port, and a long side of the discharge port preferably has a dimension that corresponds to a height of the wrap portion side face. Thus, a long side direction of the spray nozzle can be aligned with a height direction of the wrap portion side face, and therefore the coating solution can be applied in a single application to the entire wrap portion side face in a wrap width direction extending from a contact site contacting the end plate to a tip end site. As a result, a time required for a coating solution spraying process can be shortened.

With the scroll type fluid machine according to the present invention, in a scroll type fluid machine in which an elastic coating is formed on a side face of a spiral wrap portion, the elastic coating is obtained by dispersing a powdered solid lubricant in a synthetic resin that possesses elasticity and is more flexible than a scroll base material constituting the wrap portion, and is formed at a coating thickness at which a state of elastic deformation can be maintained relative to an opposing wrap portion side face of another scroll during an operation while ensuring that a clearance is not generated between the wrap portion side faces. Therefore, favorable lubricating and sliding properties can be obtained in relation to opposing wraps of a fixed scroll and an orbiting scroll, and as a result, seizure, galling ,wear, contact damage, and the like between opposing wrap portion side faces can be suppressed. Further, favorable adhesiveness is realized in relation to the opposing wrap portion side face, and as a result, the enclosed space formed between the fixed scroll and the orbiting scroll can be sealed more tightly.

With the method according to the present invention, a method for forming an elastic coating on a scroll type fluid machine in which the elastic coating is formed on a side face of a spiral wrap portion includes: a preliminary step of fixing a scroll constituted by the wrap portion and an end plate to a rotating table and rotating the scroll about a spiral center of the wrap portion; a coating solution spraying step of moving a spray nozzle in a radial direction of the scroll while spraying a coating solution obtained by dissolving constituent components of the elastic coating in a solvent, onto the rotating scroll toward the wrap portion side face using the spray nozzle; and a coating thickness adjusting step of keeping a coating thickness of the coating solution constant by adjusting a rotation speed of the scroll in accordance with a radial direction movement of the spray nozzle. By adjusting the rotation speed of the scroll and a radial direction movement speed of the spray nozzle relative to the scroll while spraying the coating solution, the coating can be formed at an even coating thickness. As a result, an elastic coating having an even coating thickness can be formed on a wrap portion side face of a scroll easily.

Hence, at low cost, the enclosed space of the scroll type fluid machine can be sealed more tightly, and galling, wear, damage, and the like between the wrap portions can be suppressed. As a result, an operating efficiency of the scroll type fluid machine can be improved.

Further, with the elastic coating formation device according to the present invention, a device for forming an elastic coating on a scroll type fluid machine in which an elastic coating is formed on a side face of a spiral wrap portion includes: a rotation device that includes a rotating table on which a scroll constituted by the wrap portion and an end plate is placed fixedly and a driving device for driving the rotating table, and that rotates the scroll placed fixedly on the rotating table about a spiral center of the wrap portion; a coating solution spraying device having a spray nozzle for spraying a coating solution obtained by dissolving constituent components of the elastic coating in a solvent, onto the rotating scroll toward the wrap portion side face, and a driving device for moving the spray nozzle in a radial direction of the scroll; and a controller that keeps a coating thickness of the coating solution constant by controlling a rotation speed of the rotating table and a movement speed of the spray nozzle. As a result, similar actions and effects to those of the method according to the present invention can be obtained.

### BRIEF DESCRIPTION OF THE DRAWINGS

FIG. 1 is a partially enlarged sectional view showing a scroll type fluid machine according to a first embodiment of the present invention;

FIG. 2 is a perspective view showing a method and a device for forming an elastic coating according to the first embodiment of the present invention;

FIG. 3 is a partial front view showing an elastic coating formation device according to the first embodiment;

FIG. 4 is a table showing results of a test performed on the elastic coating according to the first embodiment;

FIG. 5 is a partial front view showing a method and a device for forming an elastic coating according to a second embodiment of the present invention;

FIG. 6 is a perspective view showing a spray nozzle according to the second embodiment; and

FIG. 7 is a partial sectional view showing thermal deformation in a scroll type compressor.

### BEST MODE FOR CARRYING OUT THE INVENTION

The present invention will be described in detail below using embodiments shown in the drawings. Note, however, that unless specific description is provided to the contrary, dimensions, materials, shapes, relative arrangements, and the like of constituent components described in the embodiments are not intended to limit the scope of the present invention.

### First Embodiment

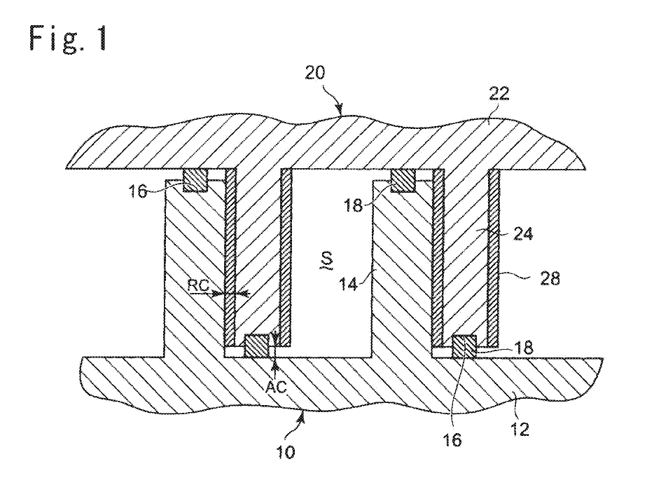

A first embodiment of a scroll type fluid machine and a method and a device for forming an elastic coating thereon according to the present invention will now be described on the basis of FIGS. 1 to 4. FIG. 1 shows a meshing portion between a fixed scroll 10 and an orbiting scroll 20 of a non-lubricated scroll type air compressor. In FIG. 1, the aluminum fixed scroll 10 is constituted by a disc-shaped end plate 12 and a spiral wrap portion 14 that stands upright from the end plate 12 in a right-angle direction. The aluminum orbiting scroll 20 is similarly constituted by a disc-shaped end plate 22 and a spiral wrap portion 24 that stands upright from the end plate 22 in a right-angle direction.

Spiral recessed grooves 16 are engraved in respective end surfaces of the wrap portions 14 and 24, and spiral tip seals 18 are fitted tightly into the recessed grooves 16. A clearance AC between the respective end plates 12, 22 and the respective wrap portions 14, 24 is tightly sealed by the tip seals 18. Further, an elastic coating 28 is formed on a wrap portion side face 24a in order to seal up a clearance RC between the wrap portions 14, 24 such that an enclosed space s is formed between the fixed scroll 10 and the orbiting scroll 20.

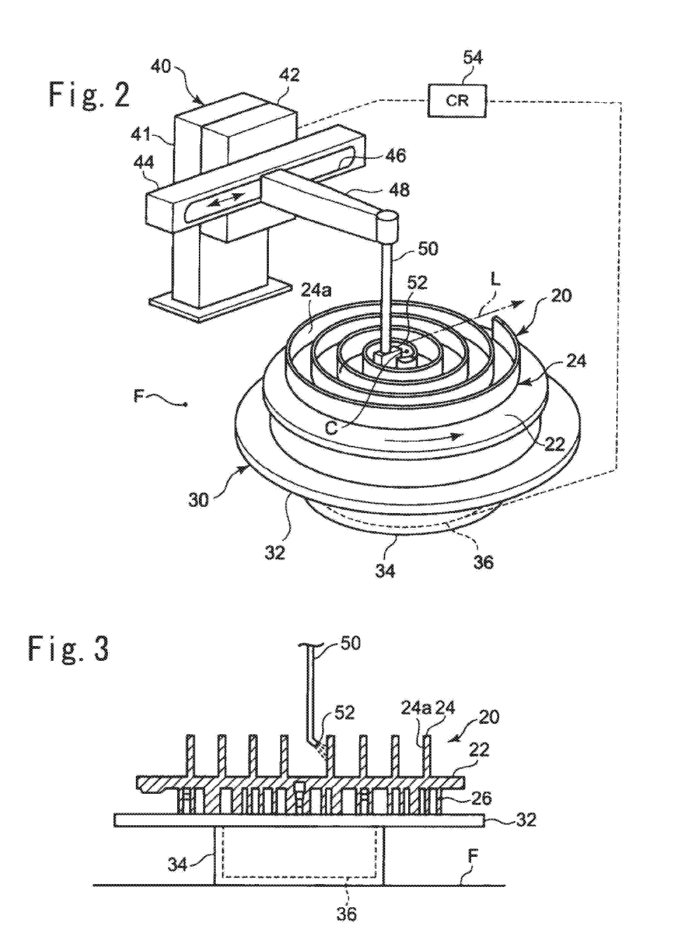

The elastic coating 28 is formed by applying a coating solution containing following components in a following composition to the wrap portion side face 24a using a coating device shown in FIGS. 2 and 3, drying the coating by baking so that the coating is hardened, and then breaking
in the scroll type compressor so that the coating is formed on the wrap portion side face 24a at a coating thickness enabling elastic deformation.

The coating solution contains 10 to 20% by weight of epoxy resin serving as a thermosetting resin, 20 to 30% by weight of MoS₂, and 5 to 10% by weight of graphite, with the remainder constituted by an organic solvent. Next, a coating method using the coating device shown in FIGS. 2 and 3 will be described.

In FIGS. 2 and 3, a large number of radiator fins 26 are formed integrally with a back surface of the end plate 22 of the orbiting scroll 20. A rotation device 30 for rotating the orbiting scroll 20 is placed on a floor surface F. The rotation device 30 includes a disc-shaped rotating table 32 having a larger diameter than the end plate 22, a casing 34 attached to a lower portion of the rotating table 32, and a driving device 36 housed in the casing 34 in order to rotate the rotating table 32.

A coating solution spraying device 40 is fixed onto the floor surface F in the vicinity of the rotation device 30. The coating solution spraying device 40 includes a main body portion 41 having an inbuilt coating solution storage tank, not shown in the drawings, an inbuilt driving device 42 and the like that causes an arm 48, to be described below, to reciprocate in a direction of an arrow, and a guiding frame 44 having a recessed groove 46 along which the arm 48 slides in the direction of the arrow. The recessed groove 46 is disposed in a horizontal direction and has a rectilinear groove shape.

The arm 48 is engaged to the recessed groove 46 to be free to slide in the direction of the arrow, and thus the arm 48 is moved by the driving device 42 in the direction of the arrow while remaining oriented toward the orbiting scroll 20 side. A downwardly oriented nozzle pipe 50 is attached to a tip end of the arm 48. The aforesaid coating solution is supplied to the nozzle pipe 50 from the main body portion 41 side. A spray nozzle 52 for discharging the coating solution is attached to a lower end of the nozzle pipe 50. The spray nozzle 52 is bent diagonally downward from the nozzle pipe 50 such that a circular coating solution discharge port opposes the wrap portion side face 24a of the orbiting scroll 20.

The spray nozzle 52 moves while maintaining an identical attitude. In other words, there is no need to provide a mechanism for modifying the attitude of the spray nozzle 52. The arm 48 moves in the horizontal direction along a rectilinear movement path L by moving along the recessed groove 46. A controller 54 controls a rotation angle speed of the rotating table 32 by controlling the driving device 36, and controls a movement speed of the spray nozzle 52 in the direction of the rectilinear movement path L by controlling the driving device 42.

With this configuration, when the coating solution is to be applied to the wrap portion side face 24a of the orbiting scroll 20, the orbiting scroll 20 is placed on the rotating table 32 and positioned such that a spiral center C of the wrap portion 24 is positioned in a rotary center of the rotating table 32. Next, the spray nozzle 52 is disposed in the spiral center C, whereupon the attitude of the spray nozzle 52 is adjusted such that the coating solution discharge port opposes the wrap portion side face 24a in the spiral center position.

In this condition, the rotating table 32 is rotated in a direction of an arrow such that the coating solution is discharged from the spray nozzle 52 and sprayed onto the wrap portion side face 24a. The spray nozzle 52 is then moved along the rectilinear movement path L toward a radial direction outer side of the orbiting scroll 20 in while maintaining attitude thereof at the start of the spraying process.

At this time, the controller 54 controls the movement speed of the spray nozzle 52 to a constant speed, and gradually reduces the rotation angle speed of the rotating table 32 in accordance with the movement of the spray nozzle 52 in an outer peripheral direction of the orbiting scroll 20 from the spiral center C while keeping a distance between the nozzle tip end and the wrap portion side face 24a constant. If the orbiting scroll 20 is rotated at an identical rotation angle speed throughout the coating solution application process, a peripheral speed of the orbiting scroll 20 increases steadily in the outer peripheral direction from the spiral center C. As a result, a coating thickness of the coating solution applied to the wrap portion side face 24a decreases steadily from a central region toward an outside region.

The controller 54 controls the coating thickness to remain even from the central region to the outside region of the wrap portion side face 24a by gradually reducing the rotation angle speed of the rotating table 32 in accordance with the radial direction movement of the spray nozzle 52. When it is not possible to apply the coating solution to the entire wrap portion side face 24a in a single application, an identical operation is performed again so that the entire wrap portion side face is coated.

The coating solution need only be applied to the wrap portion side face that contacts the wrap portion 24 of the orbiting scroll 20.

Following the application process, the coating is dried by baking, whereby the organic solvent evaporates and the epoxy resin hardens. The coating thickness of the elastic coating 28 thus formed on the wrap portion side face 24a of the orbiting scroll 20 is set to exceed the coating thickness that enables elastic deformation during an operation of the scroll type compressor. Following drying by baking, the scroll type compressor is broken in to finish the elastic coating 28 from a coating thickness that causes plastic deformation to the coating thickness that enables elastic deformation in accordance with the clearance RC between the wrap portion side faces. In so doing, the coating thickness of the coating solution does not have to be controlled finely during the application process.

During the break-in operation, the elastic coating 28 is finished to the coating thickness that enables elastic deformation from the coating thickness that causes plastic deformation either by plastically deforming the elastic coating 28 on the wrap portion side face 24a or by scraping away or wearing down a surface of the elastic coating 28 on the opposing wrap portion side face.

### EXAMPLES

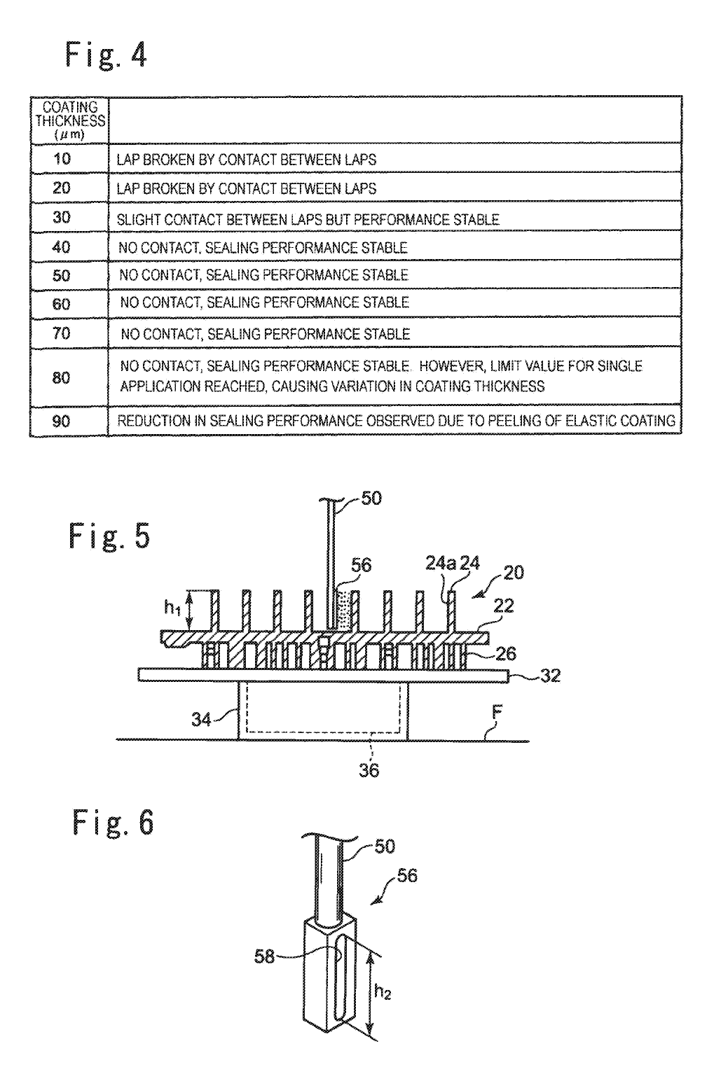

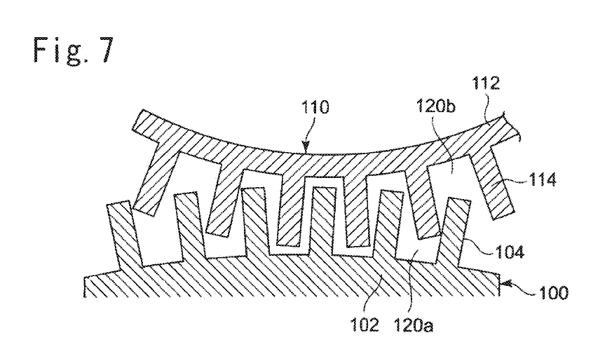

A scroll type air compressor including the elastic coating 28 having the components and composition described above on one side face of the wrap portion 24 was operated, whereupon a damaged condition of the wrap portion 24 and a sealing condition between the wrap portion side faces were inspected. Results are shown in FIG. 4. In the inspection, the clearance RC between the wrap portion side faces of the fixed scroll 10 and the orbiting scroll 20 was changed variously, the elastic coating 28 was formed at different coating thicknesses by performing the coating formation process described above in accordance with the clearances RC, and the inspection was performed using the formed elastic coatings 28.

It is evident from FIG. 4 that when the elastic coating 28 is between 30 and 80 μm, contact between the opposing wrap portions 24 is alleviated, and therefore damage to the wrap portions can be prevented and a favorable sealing condition can be maintained between the wrap portion side faces of the two wrap portions. It was found that when the coating thickness is less than 30 μm, a large impact is generated when the wrap portions collide, as a result of which the wrap portions may be damaged. It was also found that when the coating thickness equals or exceeds 90 μm, the elastic coating 28 is more likely to peel.

Further, it was discovered that when a composition range of the epoxy resin is smaller than the aforesaid composition range, an adhesive force of the elastic coating 28 relative to the wrap portion side face decreases, and when the composition range of the epoxy resin is greater than the aforesaid composition range, the elasticity of the elastic coating 28 decreases. It was therefore learned that the adhesive force and the elasticity of the elastic coating can be optimized within the aforesaid composition range of the epoxy resin. Further, it was found that when the composition range of the solid lubricant is smaller than the aforesaid composition range, the lubricating property and the sliding property relative to the wrap portion side face decrease, and when the composition range of the solid lubricant is greater than the aforesaid composition range, the strength of the elastic coating and the adhesive force thereof relative to the wrap portion side face decrease. It was therefore learned that the strength, lubricating property, sliding property, and adhesive strength of the elastic coating relative to the wrap portion side face can be optimized within the aforesaid composition range of the solid lubricant.

Note that polytetrafluoroethylene (PTFE) may be added to the epoxy resin within the range of the aforesaid composition range. Further, a solid lubricant constituted by MoS₂ alone may be used as the solid lubricant within the range of the aforesaid composition range.

MoS₂ and graphite are self-lubricating, and therefore, when the present invention is applied to a non-lubricated scroll type air compressor, as in this embodiment, a lubricating property can be maintained between the wrap portions even without the use of lubricating oil.

Further, by employing the coating device and coating method shown in FIGS. 2 and 3, the elastic coating 28 can be formed on the wrap portion side face 24a of the orbiting scroll 20 at an even coating thickness from the spiral center C to the outside end. Moreover, the movement speed of the spray nozzle 52 remains constant, and therefore even thickness of the elastic coating 28 can be realized by simple control in which only the rotation angle speed of the rotating table 32 is controlled. Since complicated control is not required, a simple and inexpensive control device can be used as the control device.

Furthermore, during the application process, the spray nozzle 52 is simply moved rectilinearly along the rectilinear movement path L while maintaining attitude thereof at the start of the application process. Therefore, a uniaxial system driving mechanism may be used as a mechanism for driving the spray nozzle 52. As a result, the configuration of the driving device 42 of the coating solution spraying device 40 can be simplified, enabling a reduction in cost.

Note that in the first embodiment, an operation start position of the spray nozzle 52 is set as the spiral center C of the wrap portion 24, and once the coating solution spraying process has begun, the spray nozzle 52 is moved in the outer peripheral direction of the orbiting scroll 20. Instead, however, the start position of the spray nozzle 52 may be set as the outside end of the wrap portion 24, and once the coating solution spraying process has begun, the spray nozzle 52 may be moved toward the spiral center C side of the orbiting scroll 20. In this case, the rotation angle speed of the rotating table 32 is gradually increased in accordance with the movement speed of the spray nozzle 52.

In the first embodiment, the coating solution spraying device 40 that moves the arm 48 using a uniaxial system driving mechanism is employed, but instead, the arm 48 may be moved three-dimensionally using a multiaxial system driving mechanism.

### Second Embodiment

Next, a second embodiment of the coating method according to the present invention will be described using FIGS. 5 and 6. A discharge port 58 of a spray nozzle 56 takes the shape of an elongated slit extending in a vertical direction. A dimension h₂ of a long side of the discharge port 58 is set to be substantially identical to a height dimension h₁ of the wrap portion side face 24a. Hence, when the coating solution is discharged from the discharge port 58, the coating solution can be applied to the entire region of the wrap portion side face 24a in a height direction extending from a connecting portion connected to the end plate 22 to a tip end portion in a single application. All other configurations of the coating device are identical to the first embodiment.

In the first embodiment and the second embodiment, examples in which the elastic coating is formed on the wrap portion of the orbiting scroll were described, but the elastic coating may be formed on the wrap portion of the fixed scroll instead. Further, the present invention may be applied to other scroll type fluid machines.

### INDUSTRIAL APPLICABILITY

According to the present invention, an elastic coating can be formed easily on a wrap portion side face of a scroll type fluid machine while maintaining a tight seal between wrap portion side faces and preventing seizure, galling, wear, contact damage, and the like between wrap portions.

1. A device for forming an elastic coating on a scroll type fluid machine, in which an elastic coating is formed on a side face of a spiral wrap portion, the elastic coating is obtained by dispersing a powdered solid lubricant in a synthetic resin that possesses elasticity and is more flexible than a scroll base material constituting the wrap portion, and is formed at a coating thickness that enables elastic deformation relative to an opposing wrap portion side face of another scroll during an operation while ensuring that a clearance is not generated between the wrap portion side faces is formed on a side face of a spiral wrap portion, the device comprising:
a rotation device that includes a rotating table on which a scroll constituted by the wrap portion and an end plate is placed fixedly and a driving device for driving the rotating table, and that rotates the scroll placed fixedly on the rotating table about a spiral center of the wrap portion;
a coating solution spraying device having a spray nozzle for spraying a coating solution obtained by dissolving constituent components of the elastic coating in a solvent, onto the rotating scroll toward the wrap portion side face, and a driving device for moving the spray nozzle in a radial direction of the scroll; and
a controller that keeps a coating thickness of the coating solution constant by controlling a rotation speed of the rotating table and a movement speed of the spray nozzle.

2. The device for forming an elastic coating on a scroll type fluid machine according to claim 1, wherein the coating solution spraying device comprises a uniaxial system driving device that moves the spray nozzle along a rectilinear path without varying an attitude of the spray nozzle.

3. The device for forming an elastic coating on a scroll type fluid machine according to claim 1, wherein the spray nozzle comprises a slit-shaped discharge port, and a long side of the discharge port has a dimension that corresponds to a height of the wrap portion side face.
